(19) United States
(12) Patent Application Publication
(10) Pub. No.: US 2003/0134589 A1
(43) Pub. Date: Jul. 17, 2003

(54) Porable radio terminal with musuc data download function

(76) Inventor: Masaru Oba, Kanagawa (JP)

Correspondence Address: PEARNE & GORDON LLP, 526 SUPERIOR AVENUE EAST, SUITE 1200, CLEVELAND, OH, 44114-1484, US

(21) Appl. No.: 10/296,373

(22) PCT Filed: Feb. 28, 2002
(86) PCT No.: PCT/JP02/01875

(30) Foreign Application Priority Data
Mar. 7, 2001 (JP) 2001-63852

(51) Int. Cl. H04B 1/38; H04M 1/00

(52) U.S. Cl. 455/3.03; 455/556; 455/414

(57) ABSTRACT

An object of the present invention is to provide a portable wireless terminal equipped with a music data download function, which is provided with a reservation function used to download music data at a designated time instant.

The portable wireless terminal of the present invention is comprised of: a control means (1) for controlling a line establishment of the portable wireless terminal and transmission/reception of data; a communication interface means (2) for transmitting/receiving a command signal, music data, music data information, and processing load information via the line for the portable wireless terminal with respect to a download center; a display means (3) for displaying thereon information related to transmission/reception data and an input request; a selection means (4) for performing various sorts of selection operations based upon the displayed information; a storage means (5) for storing thereinto the downloaded music data; and a reservation means (6) for designating a download time instant of the music data.

### TECHNICAL FIELD

The present invention is related to a portable wireless terminal equipped with a music data download function.

### BACKGROUND ART

Systems have been proposed and are utilized in which music data is downloaded from a remote music data delivery firm (will be referred to as a “download center” hereinafter) via a line for a portable wireless terminal to the portable wireless terminal, and the downloaded music data is reproduced in this portable wireless terminal.

However, several minutes are required so as to download music data per one music piece, although depending upon lengths of music pieces, data compression ratios thereof, and data transfer rates thereof. Lengthy time is required in the case that a plurality of music pieces are downloaded. When this downloading operation is commenced within such a time range that the normal speech (voice) telephone communications, or character communications of a portable wireless terminal are carried out many times, the telephone communications, the character communications, and the reproductions of music pieces cannot be executed during this time range, resulting in inconvenient operabilities of the portable wireless terminal.

In general, as to an expense required for downloading music data, this downloading expense is a total amount of both a charge of the music data itself and a communication fee charged based upon communication time. In a case that reception conditions of portable wireless terminals are not so good, and/or access operations to a download center are concentrated, since throughputs of the download center are low, communication time would be prolonged. There is a problem that communication cost is increased in such a charging system executed based upon communication time.

Furthermore, as previously explained, when a throughput is low, communication cost is increased. As a result, even in such a case that the same music data is downloaded, there is another problem that expenses required for downloading this same music data are different from each other, depending upon delivery firms.

The present invention has been made to solve the above-described problems, and therefore, has an object to provide a portable wireless terminal equipped with a music data download function, which is provided with a reservation function capable of downloading music data at a designated time instant, while avoiding such a time range during which telephone communications and reproducing operations of music data are frequently carried out, and selecting such a time range in which a use frequent degree of the portable wireless terminal is low.

Another object of the present invention is to provide a portable wireless terminal equipped with a music data download function, which is provided with a delivery firm selection function by which processing load information (throughput information etc.) is acquired every music data delivery firm, and an optimum delivery firm is automatically selected in low downloading cost.

Also, a further object of the present invention is to provide a portable wireless terminal equipped with a music data download function, which is realized by combining the above-explained two functions in order that a delivery firm is automatically selected even when a reserved downloading operation is carried out.

### DISCLOSURE OF THE INVENTION

A portable wireless terminal of the present invention is comprised of: a control means (1) for controlling a line establishment of the portable wireless terminal and transmission/reception of data; a communication interface means (2) for transmitting/receiving a command signal, music data, music data information, and processing load information via the line for the portable wireless terminal with respect to a download center; a display means (3) for displaying thereon information related to transmission/reception data and an input request; a selection means (4) for performing various sorts of selection operations based upon the displayed information; and a storage means (5) for storing thereinto the downloaded music data. Furthermore, the portable wireless terminal is comprised of either a reservation means (6) for designating a download time instant of the music data or a delivery firm selection means (7) for selecting/determining an optimum delivery firm from a plurality of music data delivery firms, or both the storage means (5) and the delivery firm selection means (7).

It should be noted that “music data” defined in the present invention basically implies voice data related to music, and may contain character data and picture data, which may be displayed on the display means. Also, the music data information implies both a bibliographical item related to music data, and additional information. The bibliographical item includes, for example, a title of a music piece, a name of a composer, a name of a songwriter, a name of a music arranger, a name of a singer, a genre of a music piece, a marketing date, a marketing firm, and the like. The additional information contains a data amount of music data, a data charge, and so on. The processing load information implies such a throughput information as a transfer speed when music data is downloaded from a data server of a download center, and time required to download an entire portion of the music data (music piece).

The control means for controlling the line establishment of the portable wireless terminal and the transmission/reception of the data implies a portion having an entire control function in the portable wireless terminal. For example, the content selected by the selection means is executed via the control means, and the executed content is transmitted, displayed, stored and the like by the communication interface means, the display means, the storage means, and the like. Also, the data and the signal, which are received by the communication interface means, are transferred, converted, displayed, stored and the like in response to a command issued from the control means. Furthermore, the control means reads a program of the reservation means, and a program of the delivery firm selection means; sets a timer; controls various sorts of judging process operations, the display means, and the selection means; and instructs a commencement of a communication with the download center, transmission/reception of a signal, an end of the communication.

The communication interface means for transmitting/receiving the command signal, the music data, the music data information, and the processing load information via the line for the portable wireless terminal with respect to the download center is connected to the download center based upon a command issued from the control means; and transmits a reception command such as the music data, the music data information, and the processing load information, and also receives the music data, the music data information, and the processing load information. Similarly, the communication interface means accomplishes the connection based upon a command sent from the means.

The display means for displaying thereon the information related to the transmission/reception data and input request; displays a list used to perform a selection by the selection means, a selected content, and information related to the music data information and the transmission/reception data, which are received from the download center.

The selection means for performing various sorts of selection operations based upon the displayed information owns such functions capable of retrieving, selecting, defining, and transmitting the content displayed on the display means. For instance, a necessary selection is executed by using a ten-key button of the portable wireless terminal, and buttons thereof to which the functions are independently allocated.

Preferably, while a series of operations are programed by interconnecting the display means with the selection means in such a manner that these operations may be executed by way of a menu selecting method, this program maybe stored in the storage means. For instance, in a program connected to a delivery firm, when a menu of delivery firm list indication is selected by the selection means, address data of download centers stored in the storage means are read out via the control means and then are displayed as a list on the display means. When the list is retrieved and a name of a desirable delivery firm is selected by the selection means, a connection request is informed from the control means to the communication interface means, and then, the communication interface means establishes a connection between the own portable wireless terminal and the download center of the relevant delivery firm so as to transmit/receive a signal and data.

The storage means for storing thereinto the downloaded music data implies such a means for temporarily, or permanently storing thereinto data and a program. In the case of music data, this music data may be stored into a memory employed in the portable wireless terminal, or a data recording medium. As this data recording medium, no specific limitation is made, but various sorts of recording media which have been widely known may be utilized. More specifically, as storage formats of music data, voice (speech) and/or image compressed data formats may be preferable. Also, data compressions may be realized by employing various compression methods which have been widely known in the field. As previously described, in addition to the music data, various sorts of data and various sorts of programs may be stored in the storage means, while these various data contain music information data, data such as an address of a delivery firm, specific data of a user of a portable wireless terminal, and so on. These programs include a program used to download music data.

The reservation means for designating the download time instant of the music data implies such a process sequence which is formed by setting a time instant to download music data in order that the music data can be downloaded, while selecting a time range where the portable wireless terminal is not used, and another time range where access operations to a download center are not concentrated. This process sequence is stored as a program.

The delivery firm selection means for selecting/determining the optimum delivery firm from the plurality of music data delivery firms implies such a process sequence which is formed so as to automatically select a delivery firm having the lowest cost in such a manner that music data information and processing load information are acquired from a plurality of delivery firms, and expenses related to downloading operations such as data charges and communication cost are calculated. This process sequence is stored as a program.

### BRIEF DESCRIPTION OF THE DRAWING

FIG. 1 is a block diagram for indicating a system structure of a portable wireless terminal according to an embodiment mode of the present invention.

FIG. 2 is a flow chart for describing a download operation of a music data by employing the portable wireless terminal according to the embodiment mode of the present invention.

FIG. 3 is a flow chart for explaining in detail one step of the flow chart indicated in FIG. 2.

FIG. 4 is a flow chart for describing in detail one step of the flow chart represented in FIG. 2.

FIG. 5 is a flow chart for explaining in detail one step of the flow chart indicated in FIG. 2.

FIG. 6 is a flow chart for describing in detail one step of the flow chart represented in FIG. 2.

FIG. 7 is a flow chart for explaining in detail one step of the flow chart indicated in FIG. 2.

FIG. 8 is a flow chart for describing in detail one step of the flow chart represented in FIG. 2.

It should be noted that in the drawings, reference numeral 1 shows a control means; reference numeral 2 indicates a communication interface means; reference numeral 3 shows a display means; reference numeral 4 indicates a selection means; reference numeral 5 is a storage means; reference numeral 6 indicates a reservation means; reference numeral 7 denotes a delivery firm selection means; reference numeral 8 indicates a portable wireless terminal; reference numeral 10 denotes a download center; reference numeral 11 indicates a server; and reference numeral 12 shows a database.

### BEST MODE FOR CARRYING OUT THE INVENTION

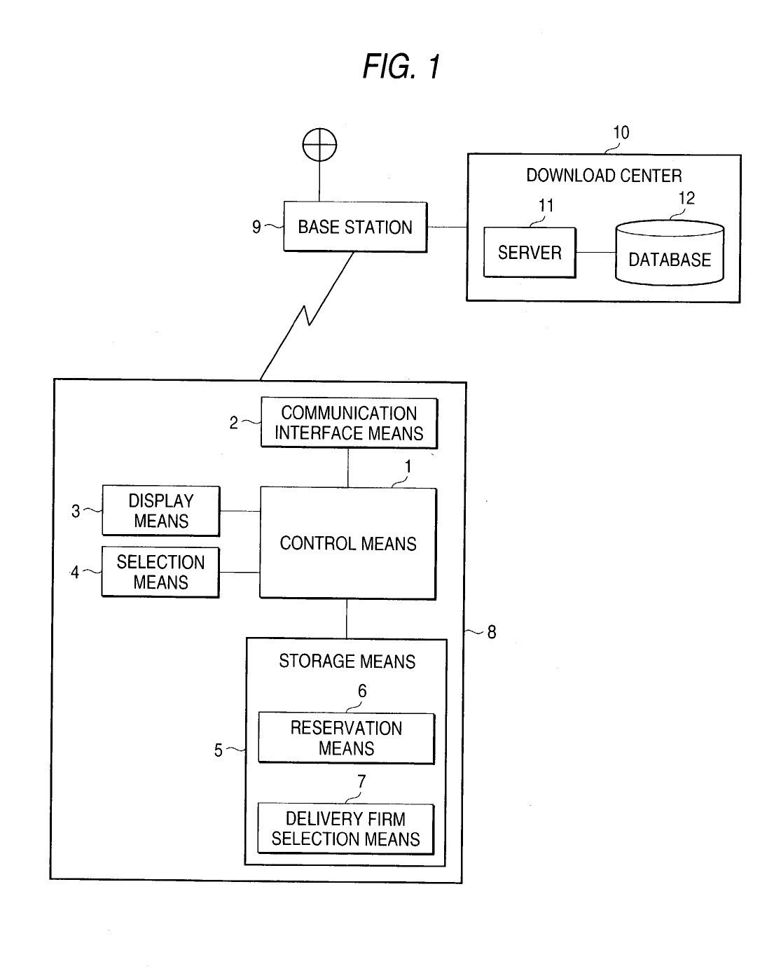

Next, an embodiment mode of the present invention will now be described with reference to drawings. FIG. 1 is a block diagram for explaining a system structure of a portable wireless terminal. This system is arranged by a control means 1, a communication interface means 2, a display means 3, a selection means 4, and a storage means 5. In this embodiment mode, the respective programs of a reservation means 6 and a delivery firm selection means 7 are stored in the storage means 5. Concretely speaking, the respective programs may be stored in a memory (not shown) employed in the portable wireless terminal 8. Alternatively, while these programs may be stored in a removable (detachable) data recording medium (not shown) of the portable wireless terminal 8, these programs may be read into the memory when the programs are initiated.

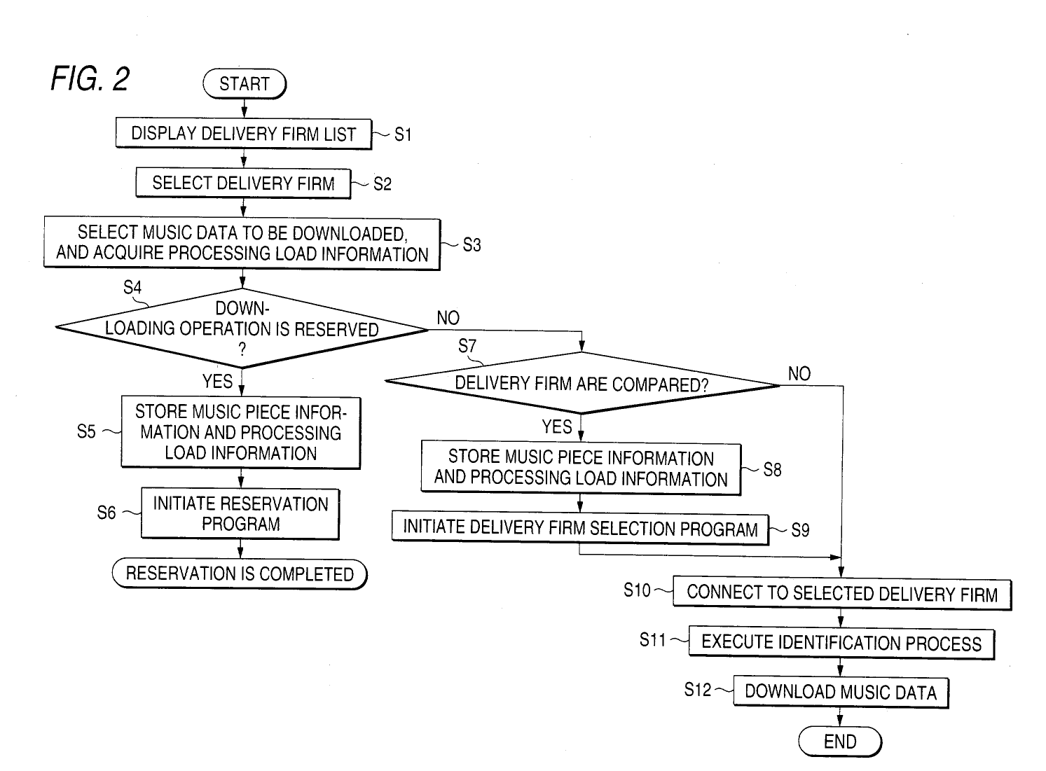

FIG. 2 is a flow chart for describing a sequential operation of music data downloading operation executed by the portable wireless terminal. In the portable wireless terminal of this embodiment mode, both download reservation of music data can be carried out, and a data delivery firm operable at a low expense of downloading operation can be automatically selected.

First, when an input operation for commencing downloading operation of music data is performed, e.g., a button is pushed in the selection means 4, a list of music data delivery firms which have been previously registered is displayed on the display means 3 (step S1) Next, a delivery firm is selected from this list (step S2). As a selection method, the number of a delivery firm displayed on the display means 3 may be entered by manipulating a ten key. Alternatively, while a cursor of the display means 3 is pointed at a display unit of a desirable delivery firm, a key used to define a selection may be depressed. When the desirable delivery firm is selected, the portable wireless terminal is automatically connected to a download center 10 of the delivery firm, and then, music data (music piece) may be selected in accordance with a program of the delivery firm. When music data to be downloaded is designated, the portable wireless terminal receives both music data information and processing load information from the download center 10 (step S3).

At a time instant when both the music data information and the processing load information are acquired, an inquiry as to whether or not this music data is reserved to be downloaded is indicated on the display means 3 (step S4). In the case that the download reservation is made, when “reservation” is selected on the selection means 4, both the music data information and the processing load information, which have been acquired, are stored in the storage means 5 (step S5), and the program of the reservation means 6 is initiated (step S6).

In the case that the download reservation is not performed, an inquiry as to whether or not a plurality of delivery firms are automatically selected at a next stage is displayed (step S7). In the case that the automatic selection of the plural delivery firms is performed, when the automatic selection is selected by the selection means 4, both the acquired music data information and the acquired processing load information are stored in the storage means 5 (step S8), and the program of the delivery firm selection means 7 is initiated (step S9).

In the case that the automatic selection is not carried out, the connection to the selected delivery firm is immediately carried out (step S10), and an identification process operation (step S11) is carried out, so that downloading operation of the music data can be carried out (step S12). All of the above-described process operations including the reservation program and the delivery firm selection program are formed in program formats, and have been stored in the storage means 5.

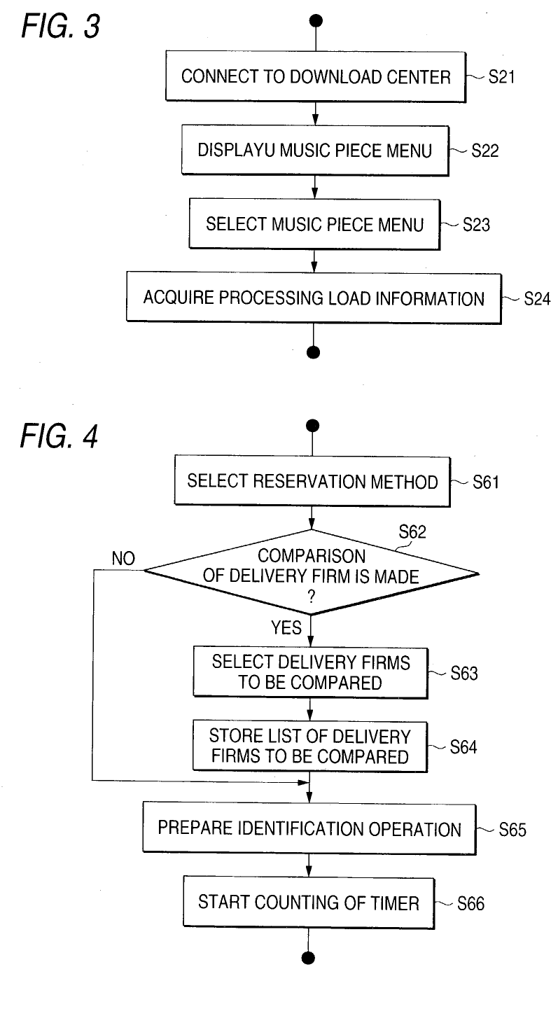

Important process operations contained in the above-explained process operations will now be explained more in detail with reference to drawings. First, FIG. 3 shows a detailed process operation in the case that the music data is selected and the processing load information is acquired (step S3). When the control means 1 senses the selection input of the delivery firm from the selection means 4, the control means 1 calls an address of the relevant download center from the storage means 5 so as to be connected to the download center 10 (step S21). A connection request is produced by the communication interface means 2 in response to a command of the control means 1, and then, is transmitted via a line for the portable wireless terminal line, a relay station 9, and a communication line to the download center 10.

When the connection is established, a menu used to select the music data is transmitted from the download center 10 and then is displayed on the display means 3 (step S22). As a music selection method, a title of music piece may be retrieved based upon a music genre and a name of an artist, or a title of music piece may be directly inputted. A music piece which is wanted to be downloaded is selected in accordance with a program of a delivery firm (step S23).

When the music data (music piece) to be downloaded is determined, the download center 10 transmits music data information and processing load information related to the determined music data. These music data information and processing load information are received by the communication interface means 2, and the contents of the received information are displayed on the display means 3 via the control means 1 (step S24). As will be explained later, the process operations defined from the step S21 to the step S24 may be automatically executed when the reserved downloading operation of the music data is carried out.

Next, process operations of the reservation program defined in the step S6 will now be explained. When the reservation is selected by the selection means 4, a menu of reservation methods is displayed on the display means 3. A desirable reservation method is selected from these reservation methods (step S61). These reservation methods will be discussed later. When the reservation method is set, another inquiry is displayed as to whether or not music data is downloaded after a delivery firm has been automatically selected when the music data is downloaded at a reserved time instant (step S62).

In the case that the delivery firm is automatically selected, the list of delivery firms is again displayed on the display means 3, and a plurality of delivery firms are selected from these delivery firms (step S63). At this time, since acquisitions of both the music data information and the processing load information are not required, only names of the delivery firms maybe selected. However, in such a case that different music pieces are wanted to be compared with each other, or in the case that a confirmation is made as to whether or not a music piece which is wanted to be downloaded is stored in this delivery firm, the process operations defined from the above-explained step S1 to step S3 are repeatedly carried out so as to select the delivery firm. After the selection has been ended, a list of the delivery firms to be compared is stored in the storage means 5 (step S64). When the present time is reached to the reserved time instant, the control means 1 checks this list, the control means 1 automatically acquires processing load information every delivery firm, and calculates expenses of downloading operations.

Next, an identification preparation operation is carried out as a preparation operation as to the reserved downloading operation (step S65). An identification operation is carried out before the downloading operation is commenced. However, while the identification operation is carried out in advance, the data of this identification operation is automatically transmitted when the reserved downloading operation is carried out. In addition, data such as fees which are required during the downloading operation are also prepared in this process operation. All of the above-described information is stored in the storage means 5. It should be noted that when the automatic selection of the delivery firm is not selected, the process operations defined subsequent to this process operation is also carried out. When all of the preparation setting operations related to the reserved downloading operation are accomplished, counting operation of a timer employed in the control means 1 is commenced (step S66), and the reservation is accomplished. When the present time is reached to the reserved time instant, the control means executes the various sorts of judging process operations in accordance with the reserved method so as to start the downloading operation of the music data.

Next, a detailed description will now be made of reservation methods. In the portable wireless terminal of this embodiment mode, four sorts of reservation methods are prepared. As these reservation methods, there are provided: (1) a user sets a time instant when a downloading operation is carried out; (2) a downloading operation is carried out in the case that the portable wireless terminal is not used in past arbitrary time; (3) a downloadable time instant is automatically set with reference to a past use history for an arbitrary time period; and (4) a downloading operation is carried out in the case that a throughput (data transfer speed) of a delivery firm is higher than, or equal to an arbitrary level.

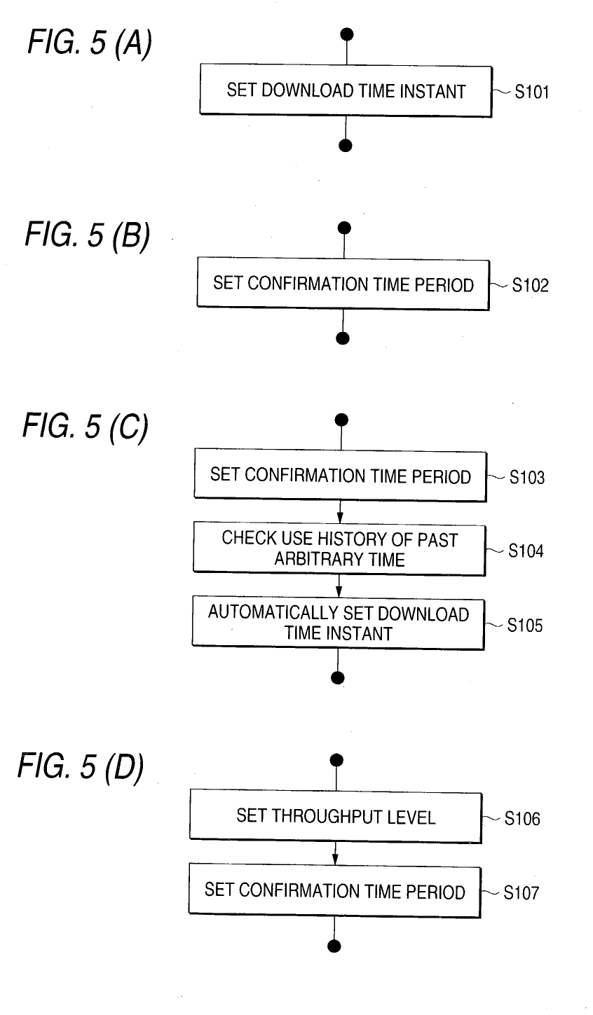

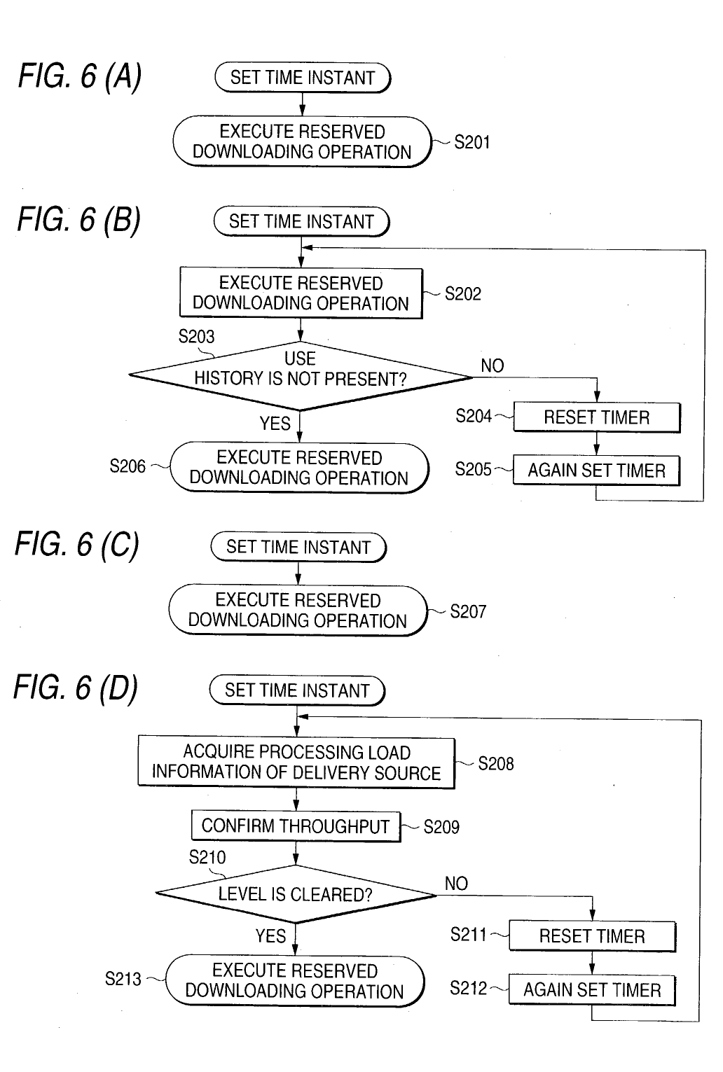

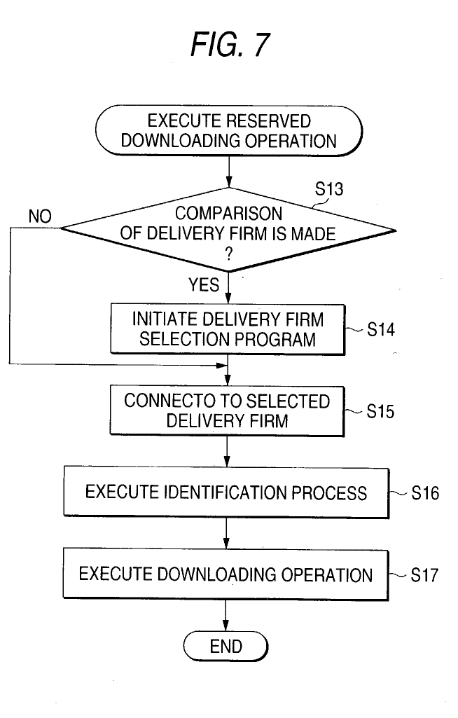

As to each of these reservation methods, both a setting process operation and a judging process operation at a setting time instant will now be explained in a concrete example with reference to FIG. 5 and FIG. 6. In the reservation method (1), the user of the portable wireless terminal predicts by himself such a time range that the use frequent degree of the portable wireless terminal is low, and then directly enters such a time instant when the downloading operation is executed from the selection means 4 (step S101). When the present time is reached to the set time instant, the reserved downloading operation is immediately carried out (step S201).

In the reservation method (2), when arbitrary time (for instance, 15 minutes) is inputted at a setting operation of a confirmation time period (step S102), the timer is set. When the present time is reached to the set time instant, the use history of the portable wireless terminal in the past arbitrary time is confirmed (step S202). In a case that a voice telephone communication call was received within the arbitrary time, the control means 1 judges that the portable wireless terminal was used (step S203), and the timer is reset (step S204) and then is again set (step S205). Thereafter, the timer starts to again count the arbitrary time. While this process loop is repeated, in the case that the user history is not present within the past arbitrary time, the control means 1 judges that the portable wireless terminal will not be used for a predetermined time period from now on, and the process operation is advanced to an execution process operation of the reserved downloading operation (step S206).

In the reservation method (3), when an arbitrary time period (for instance, 1 week) is entered in the setting operation (step S103) for the confirmation time period, the control means 1 checks a use history of the portable wireless terminal within the past arbitrary time period (step S104), extracts the closemost (latest) time range during which the time required for downloading the reserved music data can be secured, and then determines a download time instant (step S105). When the present time is reached to the set time instant, the control means 1 immediately executes the reserved downloading operation (step S207).

In the reservation method (4), when a throughput level is set (step S106) and a confirmation time period (for instance, 50 Kps, 1 hour) is set (step S107), the timer is set. When the present time is reached to the set time instant, the control means 1 acquires processing load information from the delivery firm of the music data (step S208), and confirms throughput information (step S209). In the case that access operations to the download center are concentrated, or the throughput is low, the control means 1 judges that this throughput is not the set level (step S210). After the timer is reset (step S211) and then is again set (step S212), the counting operation of the arbitrary time is again started. While this loop is repeated, in the case that the throughput clears the set level, the process operation is advanced to the execution process operation of the reserved downloading operation (step S213).

Next, process operations as to the reserved downloading operations will now be explained. As previously explained, when the present time is reached to the set time, the judging process operation is carried out with respect to each of the reservation methods, and when the condition for executing the downloading operation is cleared, the reserved downloading operation is automatically executed. First, the control means 1 judges as to whether or not the automatic selection of the delivery firm is set (step S13). In the case that the automatic selection is set, the control means 1 acquires both music data information and processing load information, and calculates an expense of downloading operation with respect to each of the delivery firms, and then, automatically selects the optimum delivery firm in accordance with the next delivery firm selection program (step S14).

When the optimum delivery firm is selected, the control means 1 is connected to the selected delivery firm (step S15), and executes an identification process operation (step S16), and thereafter, the downloading operation is commenced (step S17). The identification process operation is carried out by reading out from the storage means 5, such information which has been prepared and set when the reservation was made. When the downloading operation of the music data is accomplished, all of the works are completed.

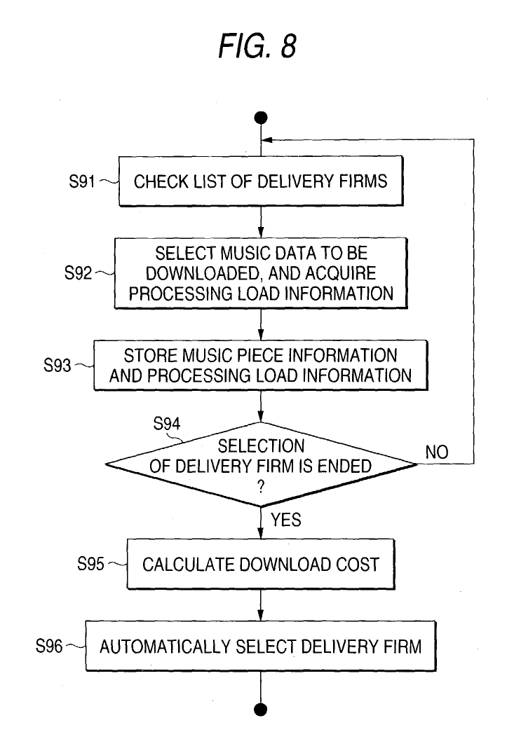

Next, a detailed description will now be made of the process operations as to all of the delivery firm selection program executed in the step S14 with reference to FIG. 8. First, the control means 1 checks a list of delivery firms (step S91) In this case, the control means 1 checks such a list of the delivery firms which were selected when the downloading operation was reserved. In a step S92, the above-described process operations defined in the step S3 of FIG. 2, namely the process operations defined from the step S21 to the step S24 of FIG. 3 are automatically carried out, in which both music data information and processing load information are acquired with respect to each of the delivery firms. While the acquired music data information and the acquired processing load information are stored (step S93), this process operation is repeatedly carried out as to the plural delivery firms (step S94). Thereafter, a calculation of download cost is automatically carried out (step S95). The control means 1 calculates time required for downloading the music data based upon both a data amount and throughput information, so that a total expense of the downloading operation may be calculated from a communication fee per hour and a data charge. A delivery firm whose downloading expense is the cheapest expense is selected (step S96).

Also in the step S9 of FIG. 2, the delivery firm selection program is executed. In this case, a list of such music data delivery firms which have been previously registered is checked in the step S91 of FIG. 8. The process operations defined from the subsequent step S92 up to the step S94 are executed not in the automatic mode, but are carried out in an interactive manner with a user by employing the display means 3 and the selection means 4. In the step S95 and the step S96, the delivery firm is automatically selected in a similar manner to that of the above-explained embodiment mode.

The above-described process operations correspond to conceptional sequential operations as to both the reservation functions and the delivery firm selection functions according to this embodiment mode. Since various known methods maybe used in the following methods and functions, detailed descriptions thereof are omitted, namely, extraction/transmission methods for extracting/transmitting the music data of the download center, a reception method in the communication interface means, a data format of the music data, a recording medium of the music data, a expansion method of data, a reproduction method of data, a protection method related to security and copyright, an identification method, a settlement method of a purchase fee, a changing method after downloading operation, a cutting process method of a line, and the normal voice telephone communication function, and also the normal character communication function.

Also, in this embodiment mode, one delivery firm is selected in the first stage, and after the music data to be downloaded has been selected, a decision is made as to whether or not the reservation is made. Alternatively, after a decision is made as to whether or not the reservation is made at the beginning, the music data may be selected. Furthermore, if the delivery firm selection function according to the present invention is utilized, then not only this delivery firm selection function may be used to compare the downloading expenses with each other as to the same music piece, but also may be used so as to download such a music data whose downloading cost is minimum among the different music pieces. Also, if a plurality of music data are reserved, then the reserved downloading operation may be continuously carried out. Apparently, delivery firms may be automatically selected as to the respective plural delivery firms.

It should be understood that both the reservation function and the delivery destination selection function realized in the portable wireless terminal of the present invention may be effectively and apparently utilized also in such a portable wireless terminal exclusively used to download music, from which the normal voice telephone communication function and the character communication function are eliminated. Also, if the portable wireless terminal may own such a function capable of discriminating the data communication from the normal voice telephone communication, then in such a case that the normal voice telephone communication call and the character communication call are received during the downloading operation, the control means 1 may transfer the telephone call to the user by way of the display means 3, and the user may make such a decision as to whether the telephone call is accepted, or refused by using the selection means 4. In the case that the user accepts the telephone call, the downloading operation may be interrupted and may be restarted after the telephone communication is ended.

While the present invention has been described in detail with reference to the specific embodiment modes, it is obvious for those skilled in the art that the present invention may be freely modified and changed without departing from the technical spirit and scope of the present invention.

It should be noted that the present patent application has been made based upon Japanese Patent Application (No. 2001-063852) filed on Mar. 7, 2001, and contents of this Japanese Patent Application are incorporated herein as references.

### INDUSTRIAL APPLICABILITY

As previously described, in accordance with the portable wireless terminal of the present invention, the music data can be automatically downloaded within the time range during which the portable wireless terminal is not used due to the reservation function of the downloading time instant. As a result, it is possible to solve such an inconvenient operation that other functions of the portable wireless terminal cannot be used while the downloading operation is carried out. Also, due to the delivery firm automatic selection function, differences in the communication cost which are caused by changes contained in the fees and the throughputs of the music data can be calculated with respect to each of the delivery firms, and then, the delivery firm whose downloading cost is the minimum cost can be automatically selected, so that the cost related to the downloading operation of the music data can be reduced.

1. A portable wireless terminal equipped with a music data download function, comprising:
control means for controlling a line establishment of the portable wireless terminal and transmission/reception of data;
communication interface means for transmitting/receiving a command signal, music data, music data information, and processing load information via the line for the portable wireless terminal with respect to a remote music data delivery firm (will be referred to as a “download center” hereinafter);
display means for performing various sorts of display operations for information related to transmission/reception data and an input request;
selection means for performing various sorts of selection operations based upon the displayed information;
storage means for storing thereinto the downloaded music data; and
reservation means for designating a download time instant of the music data.

2. A portable wireless terminal equipped with a music data download function, comprising:
control means for controlling a line establishment of the portable wireless terminal and transmission/reception of data;
communication interface means for transmitting/receiving a command signal, music data, music data information, and processing load information via the line for the portable wireless terminal with respect to a download center;
display means for performing various sorts of display operations for information related to transmission/reception data and an input request;
selection means for performing various sorts of selection operations based upon the displayed information;
storage means for storing thereinto the downloaded music data; and
delivery firm selection means for selecting/determining an optimum delivery firm from a plurality of music data delivery firms.

3. A portable wireless terminal equipped with a music data download function, comprising:
control means for controlling a line establishment of the portable wireless terminal and transmission/reception of data;
communication interface means for transmitting/receiving a command signal, music data, music data information, and processing load information via the line for the portable wireless terminal with respect to download center;
display means for performing various sorts of display operations for information related to transmission/reception data and an input request;
selection means for performing various sorts of selection operations based upon the displayed information;
storage means for storing thereinto the downloaded music data;
reservation means for designating a download time instant of the music data; and
delivery firm selection means for selecting/determining an optimum delivery firm from a plurality of music data delivery firms.

4. A portable wireless terminal equipped with a music data download function as claimed in claim 1, or claim 3 wherein:
the determining method of the download time instant in said reservation means is determined based upon a past use history of the portable wireless terminal.

5. A portable wireless terminal equipped with a music data download function as claimed in claim 1, or claim 3 wherein:
the determining method of the download time instant in said reservation means is determined based upon the processing load information such as throughput information transmitted from the download center.
